(19) United States
(12) Patent Application Publication
(10) Pub. No.: US 2014/0367950 A1
(43) Pub. Date: Dec. 18, 2014

(54) Boat Carrier Apparatus For A Tow Vehicle

(71) Applicant: Terry W. Hime, Troy, IL (US)

(72) Inventor: Terry W. Hime, Troy, IL (US)

(21) Appl. No.: 14/303,247

(22) Filed: Jun. 12, 2014

Related U.S. Application Data
(60) Provisional application No. 61/834,182, filed on Jun. 12, 2013.

(51) Int. Cl. B60P 3/10; B60R 9/048

(52) U.S. Cl. CPC B60P 3/1008; B60R 9/048
USPC 280/769

(57) ABSTRACT

A boat carrier system for a tow vehicle has a carrier frame mounted to the tow vehicle and configured to secure a boat and trailer above the tow vehicle. A boom stored on the tow vehicle is configured for lifting the boat and trailer to and from the carrier frame. The tow vehicle includes a hitch configured to secure a second tow article.

### CROSS-REFERENCE TO RELATED APPLICATIONS

This application derives and claims priority from Provisional U.S. Patent Application Ser. No. 61/834,182 filed Jun. 12, 2013, which is hereby incorporated by reference.

### STATEMENT REGARDING FEDERALLY SPONSORED RESEARCH

Not Applicable.

### BACKGROUND

Boat storage and transport is an issue for every boat owner. Choosing a storage facility depends on a variety of factors, such as the size of the boat, the storage location, protection from outdoor elements, security, duration of storage, and cost. Typically, the least expensive storage option is storing the boat at a place of residence, such as in a driveway or backyard. Alternatively, smaller boats can be put in rack storage facility, which typically stores boats in covered sheds on trailer-like cradles. For owners of larger boats, and owners of small boats who crave convenience, a marina slip can be the best choice.

Boats that are not stored at a marina must be transported and placed in the water prior to use. Typically, the boat is secured to a trailer and towed from the storage facility to the water with a tow vehicle and hitch. However, most tow vehicles cannot haul more than one article. This poses a problem for anyone that wants to transport a boat and another article, such as a camper. Currently, the only way to transport multiple articles is to use multiple tow vehicles.

Therefore, there is a need for boat carrier for a tow vehicle that does not use the hitch.

### DESCRIPTION OF THE DRAWINGS

In the accompanying drawings which form part of the specification:

FIG. 1 is a side view of a boat secured to a boat carrier mounted to a tow vehicle;

FIG. 2 is a front view of the boat secured to the boat carrier mounted to the tow vehicle;

FIG. 3 is a rear view of the boat being loaded onto to boat carrier by a boom;

FIG. 4 is a side view of the boat being loaded onto the boat carrier by the boom;

FIG. 5 is another side view of the boat secured to the boat carrier mounted to the tow vehicle;

FIG. 6 is a front view of the boat being loaded onto to boat carrier by a boom; and

FIG. 7 is another side view of the boat being loaded onto the boat carrier by the boom.

Corresponding reference numerals indicate corresponding parts throughout the several figures of the drawings.

### DETAILED DESCRIPTION

The following detailed description illustrates the claimed invention by way of example and not by way of limitation. The description clearly enables one skilled in the art to make and use the disclosure, describes several embodiments, adaptations, variations, alternatives, and uses of the disclosure, including what is presently believed to be the best mode of carrying out the claimed invention. Additionally, it is to be understood that the disclosure is not limited in its application to the details of construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting.

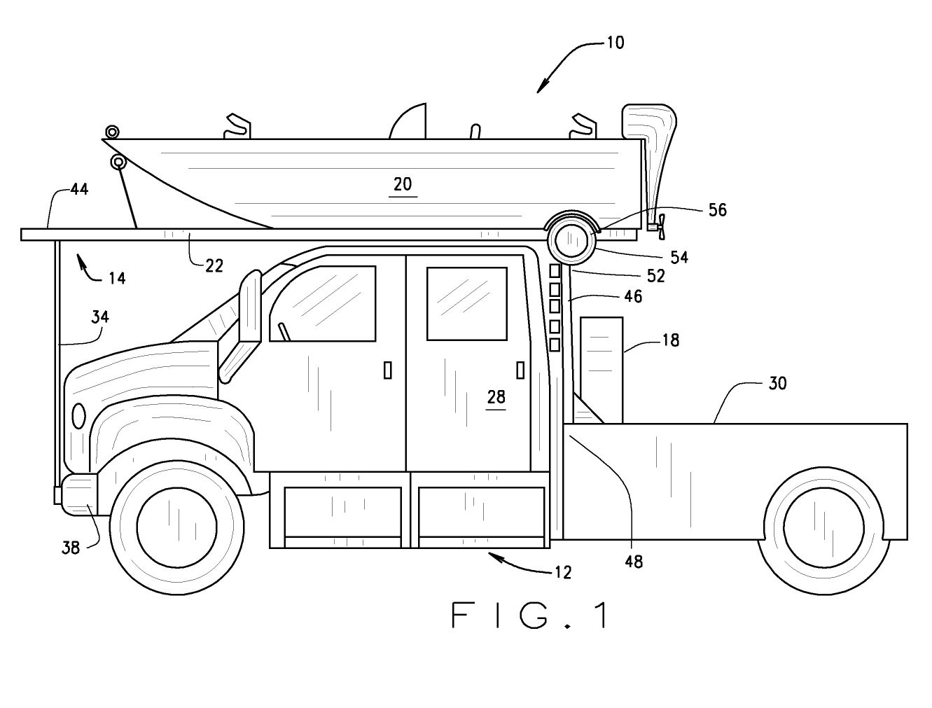

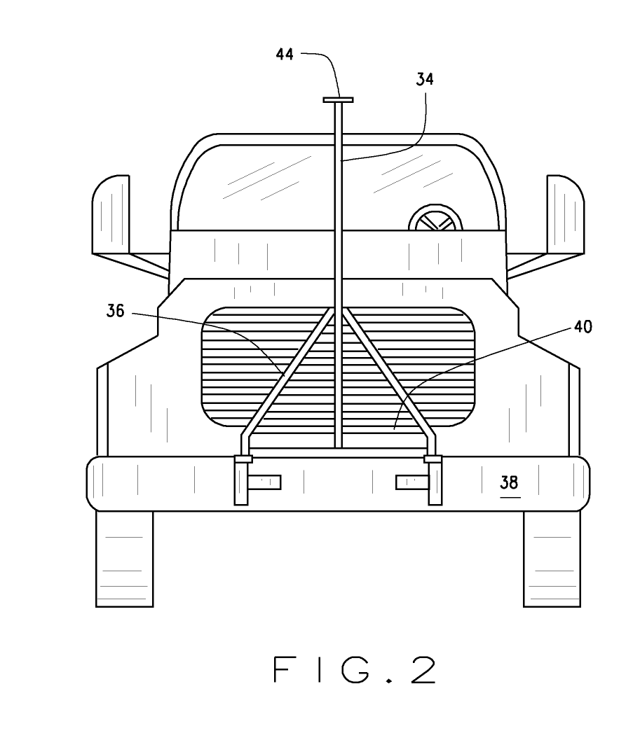

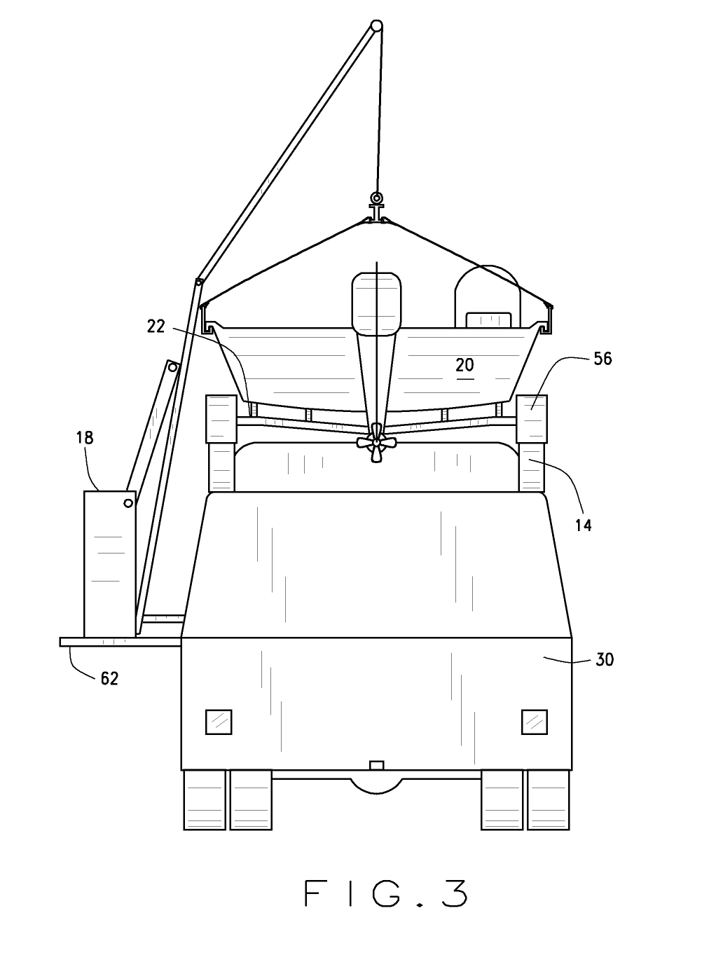

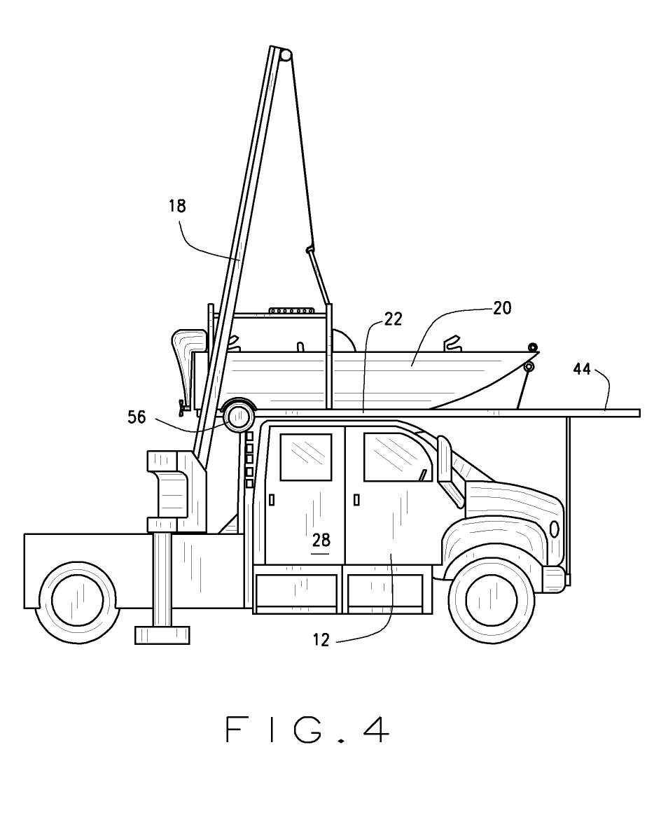

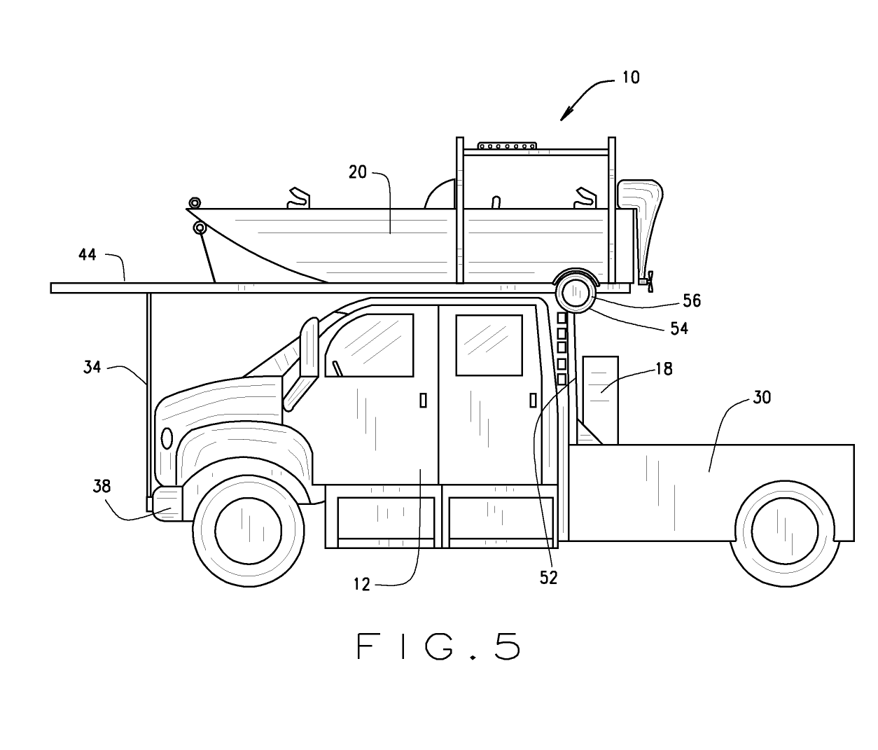

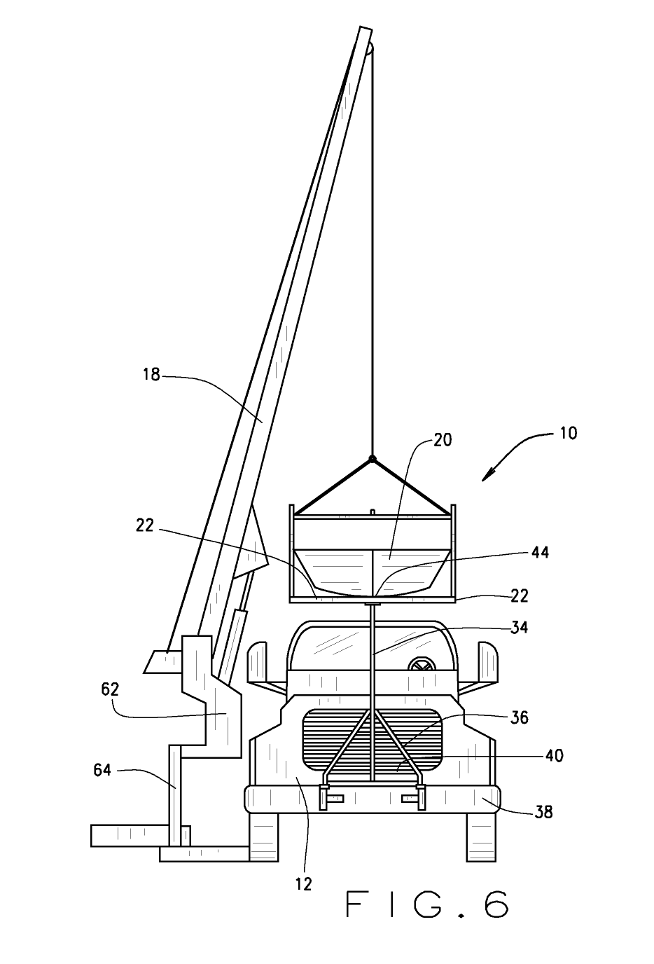

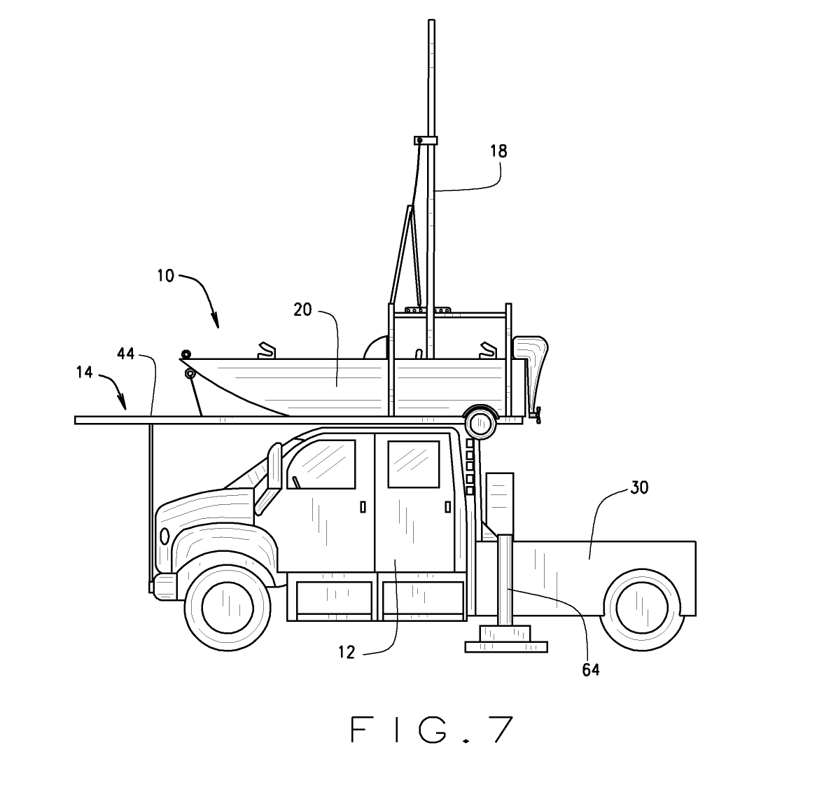

As shown in FIGS. 1-7, an embodiment constructed in accordance with the present disclosure, generally referred to as a boat carrier system 10, includes a tow vehicle 12, a carrier frame 14 attached to the tow vehicle 12, and a boom 18 for lifting a boat 20 and trailer 22 to and from the carrier frame 14.

The tow vehicle 12 is preferably a truck with an extended cab 28, a truck bed 30, and an engine with adequate tow capacity for the boat 20 and a second towable article. However, any vehicle with adequate towing capacity for the boat and a second towable article can be used.

The carrier frame 14 includes a plurality of supports 34 and 46 mounted to the tow vehicle 12. A front support 34 is generally Y-shaped with lower ends 36 attached to a front bumper 38 of the tow vehicle 12, such as with fasteners or by welding. A crossbar 40 extends between the lower ends 36 for additional stability. An upper end 42 terminates in a generally U-shaped stirrup 44 that is sized and shaped to receive the boat trailer 22. A pair of rear supports 46 extend up from each front corners 48 of the truck bed 30. Lower ends 50 of the rear supports 46 preferably attach to the truck bed 30 with fasteners or welding. An upper end 52 of each rear support 46 terminates in a generally U-shaped stirrup 54 that is sized and shaped to receive the boat trailer 22, such as the wheels 56. However, the stirrups 54 can be shaped and sized to engage any portion of the trailer 22.

The boom 18 is preferably a compact portable boom, such as the precision lifting boom manufactured by FS Industries, that removably secures to the truck bed 30 for storage. The boom 18 can be independently powered, such as with a battery, or can draw power from the tow vehicle 12. When needed, the boom 18 is removed from the truck bed 30 and positioned near the tow vehicle 12 for lifting the boat 20 and trailer 22 to and from the carrier frame 14. In an alternate embodiment, the boom 18 is mounted to an extendable or pivoting platform 62 mounted within the truck bed 30. When needed, the platform 62 extends or pivots outwardly from the truck bed 30 to a position for lifting the boat 20 and trailer 22 to and from the carrier frame 14. If needed, stabilizers 64 can attach to the platform 62 or the tow vehicle 12 to support the vehicle 12 during loading of the boat 20.

In operation, the boat 20 is secured to the trailer 22, such as with straps or tie-downs. The boom 18 is positioned next to the tow vehicle 12, and the boat 20 and trailer 22. The boom 18 secures to the boat 20 and trailer 22 with an appropriate device, such as straps, cables, or chains. The boom 18 lifts the boat 20 and trailer 22 and seats the trailer 22 on the stirrups 44 and 54 of the carrier frame 14. The trailer 22 secures to the carrier frame 14, such as with straps or tie-downs. The boom 18 is unsecured from the boat 20 and trailer 22. The boom 18 is secured in the truck bed 30. These steps are reversed to remove the boat 20 and trailer 22 from the tow vehicle 12. With the boat 20 and trailer 22 secured in the carrier frame 14, the tow vehicle 12 is capable of also securing a second article to the hitch.

Changes can be made in the above constructions without departing from the scope of the disclosure, it is intended that all matter contained in the above description or shown in the accompanying drawings shall be interpreted as illustrative and not in a limiting sense.

What is claimed is:

1. A boat carrier system for a tow vehicle, comprising:
a carrier frame mounted to the tow vehicle and configured to secure a boat and trailer above the tow vehicle;
a boom stored on the tow vehicle and configured for lifting the boat and trailer to and from the carrier frame; and
wherein the tow vehicle includes a hitch configured to secure a second tow article.

2. The boat carrier system of claim 1, wherein the carrier frame comprises:
a front support having a generally Y-shaped lower end mounted to a front portion of the tow vehicle, and a generally U-shaped upper end configured for receiving the trailer;
a rear support mounted to a rear portion of the tow vehicle, the rear support having a generally U-shaped stirrup configured for receiving the tow vehicle.

3. The boat carrier system of claim 1, further comprising a platform configured to support the boom, the platform being pivotally mounted to the truck bed for movement between a secured position generally within the vehicle bed and an operation position wherein at least a portion of the platform extends generally outside of the vehicle bed.

4. The boat carrier system of claim 3, further comprising stabilizers mounted to the platform.

5. A method for transporting a boat with a tow vehicle, comprising the steps of:
providing a carrier frame mounted to the tow vehicle and configured to secure a boat and trailer above the tow vehicle;
providing a boom stored on the tow vehicle and configured for lifting the boat and trailer to and from the carrier frame;
lifting the boat with the boom and placing the boat onto the carrier frame; and
securing the boat to the carrier frame.

6. The method of claim 5, further comprising the steps:
unsecuring the boat from the carrier frame; and
removing the boat from the carrier with the boom.

7. The method of claim 5 further comprising the steps:
providing a hitch mounted to the rear of the tow vehicle; and
securing a second tow article to the hitch.
